(19) United States
(12) Patent Application Publication
(10) Pub. No.: US 2018/0307702 A1
(43) Pub. Date: Oct. 25, 2018

(54) FILE DIRECTORY SYNCHRONIZATION

(71) Applicant: Microsoft Technology Licensing, LLC, Redmond, WA (US)

(72) Inventor: Jess Andrew KUBE, Vancouver (CA)

(73) Assignee: Microsoft Technology Licensing, LLC, Redmond, WA (US)

(21) Appl. No.: 15/492,845

(22) Filed: Apr. 20, 2017

(51) Int. Cl. G06F 17/30

(52) U.S. Cl. CPC G06F 17/30174; G06F 17/30215

(57) ABSTRACT

A method for synchronizing a file system includes accessing a remote file directory hosted by one or more remote computing devices and including a plurality of remotely-stored files. For each of the plurality of remotely-stored files, a placeholder file is generated on a local computing device, each placeholder file being smaller in size than a corresponding remotely-stored file, and each placeholder file including a size indicator indicating a size of the corresponding remotely-stored file. Each placeholder file is stored such that it appears, from a perspective of an operating system of the local computing device, to require an amount of storage space equal to the size of its corresponding remotely-stored file. Based on receiving an input to open a particular placeholder file, the local computing device retrieves contents of a corresponding remotely-stored file from the remote file directory, and opens a local copy of the corresponding remotely-stored file.

### BACKGROUND

Computer files, including documents, digital photos, videos, computer source code, executable application files, and other types of data, are often stored remotely via various cloud storage or source control services. Such remote file storage services are often used as a backup solution in case of accidental loss or corruption of local data, and can also be used to conserve local storage space or enable multiple users to access and manipulate the same files.

### BRIEF DESCRIPTION OF THE DRAWINGS

FIG. 1 schematically illustrates synchronization of a file directory between a remote computing device and multiple local computing devices.

FIG. 2 illustrates an example method for synchronizing a file directory.

FIG. 3 schematically shows placeholder files on a local computing device corresponding to remotely-stored files on a remote computing device.

FIG. 4 schematically shows an example placeholder file.

FIGS. 5A-5C schematically illustrate retrieval of file contents from a remote file directory.

FIG. 6 schematically illustrates an example local computing device.

FIG. 7 schematically illustrates an example computing system.

### DETAILED DESCRIPTION

As indicated above, remote file storage services are used in a variety of settings and for a variety of reasons. When such remote file storage services are used, it is generally desirable that the remotely-stored files are viewable and able to be manipulated on local, user-accessible computing devices. Accordingly, in many solutions, local computing devices maintain local copies of each remotely-stored computer file, to ensure that those files are immediately visible and accessible to local users. However, this can lead to an inefficient use of storage space on the local computing device, as there is a possibility that storage space will be used to hold local copies of files that a user may access infrequently, or never. Further, local storage can waste network bandwidth, as changes made to files that the user accesses infrequently are synchronized between the local computing device and the remote file storage service.

Accordingly, the present disclosure is directed to a technique for on-demand synchronization of local and remote file directories. For each of a plurality of remotely-stored files held on one or more remote computing devices, a local computing device generates a placeholder file that is smaller in size than the remotely-stored file it corresponds to. Notably, each placeholder file is stored on the local computing device such that it appears, from the perspective of an operating system of the local computing device, to occupy the same amount of storage space as the remotely-stored file corresponding to the placeholder file. In this manner, a user of the local computing device can browse a local file directory and it will appear, from the user's perspective, that each of the plurality of remotely-stored files are actually present on the user's local device, and occupying the expected amount of storage space. If the local computing device receives a prompt to open one of the placeholder files, it retrieves the contents of the remotely-stored file corresponding to the placeholder file, thereby creating a local copy of the remotely-stored file. The local computing device may then open the local copy of the file as if the file had been always been stored on the local computing device.

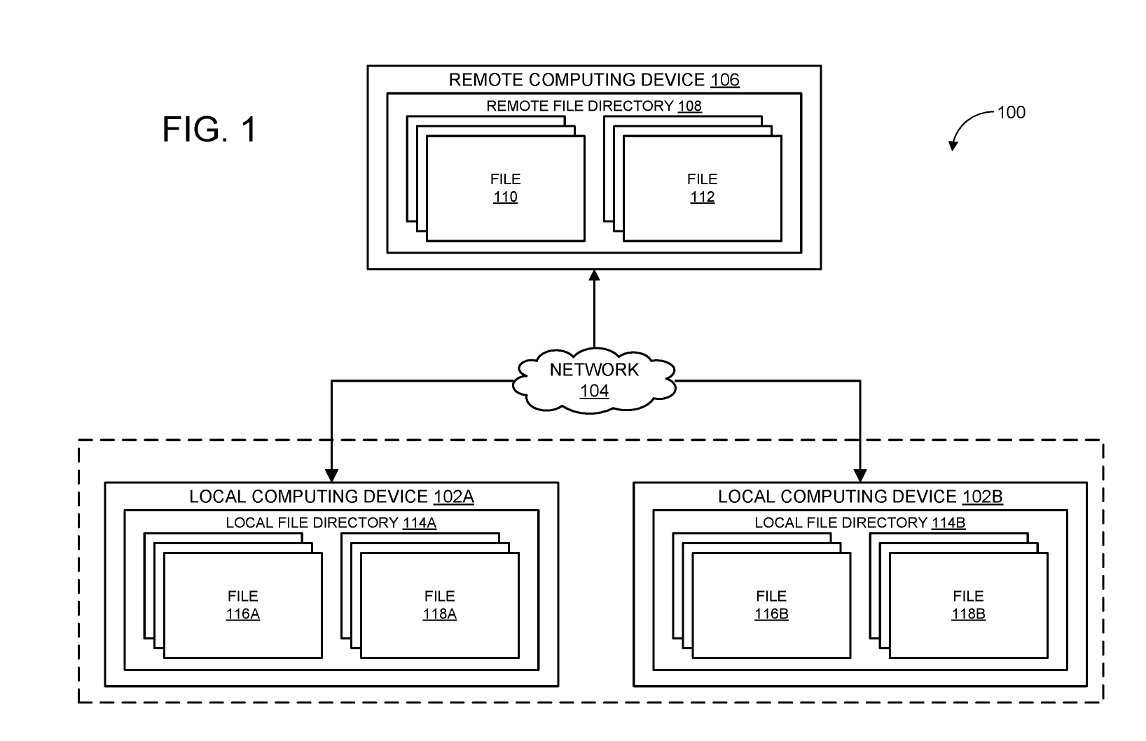

FIG. 1 schematically illustrates an example environment 100 that may be used to facilitate remote storage of computer files. Environment 100 includes two local computing devices 102A and 102B. Each of the local computing devices are configured to interface with a network 104, which may be any suitable computer network, including, for example, the Internet. Via network 104, the local computing devices are communicatively coupled with a remote computing device 106, which may be associated with a remote file storage service, for example.

A remote file storage service, as described herein, may take a variety of forms. For example, “remote file storage service” may describe a source control service used to manage changes made to remotely-stored files by multiple collaborating users. In other cases, “remote file storage service” may refer to a service that is used to store remote backups of files that are primarily accessed by and manipulated on local machines. In any case, it will be understood that a remote file storage service will be implemented on one or more remote computing devices configured to house remotely-stored files and communicate with one or more local computing devices.

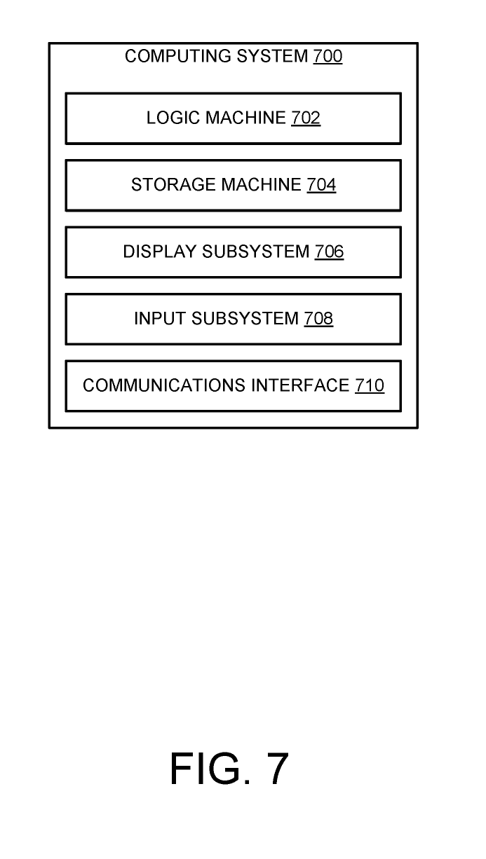

It will be understood that local computing devices 102A and 102B, as well as remote computing device 106, may take any suitable form. For example, such computing devices may be implemented as desktop computers, laptops, servers, tablets, smartphones, wearable devices, media centers, etc. An example local computing device 600 is described below with respect to FIG. 6. Any or all of local computing devices 102A and 102B and remote computing device 108 may be implemented as computing system 700 described below with respect to FIG. 7.

As shown, remote computing device 106 includes a remote file directory 108, which in turn includes computer files 110 and 112. Computer files 110 and 112 may take any suitable form. As examples, files 110 and 112 may comprise digital photos, videos, music files, documents, multimedia files, software application executable files, system files, uncompiled computer code, etc. Further, such files may be organized in the remote file directory in any suitable way. For example, computer files may be arranged hierarchically, such that individual files are arranged into “folders,” which can in turn hold additional folders as well as files. However, it will be understood that other potential organizational schemes are covered by this disclosure, and that the file directory synchronization techniques described herein may be implemented on any suitable computer architecture running any suitable operating system, or other software.

Local computing device 102A and local computing device 102B include local file directories 114A and 114B. These directories respectively include local files 116A and 118A, and local files 116B and 118B. Files 116A and 116B may correspond to file 110 held in remote file directory 108, such that each of files 110, 116A, and 116B comprise substantially the same data. Similarly, files 118A and 118B may correspond to file 112. In this manner, changes to computer files held on any of the computing devices in environment 100 may be propagated to and synchronized with each of the other computing devices in environment 100. As an example, if a user of local computing device 102A modifies file 116A (by editing a digital image, adding text to a document, deleting the file, etc.), changes to file 116A may be automatically applied to files 110 and 116B. Accordingly, regardless of which of the computing devices in environment 100 are used to access a particular file, the same data may be viewed and manipulated.

As indicated above, remote file storage solutions in which computer files are stored in their entirety on both remote and local computing devices can have drawbacks. Using FIG. 1 as an example, if a user of local computing device 102B never accesses or modifies files 116B and 118B, then storing those files on local computing device 102B will simply waste storage space. Further, network bandwidth will be wasted as changes made to computer files 116A and 118A on local computing device 102A are synchronized with local computing device 102B.

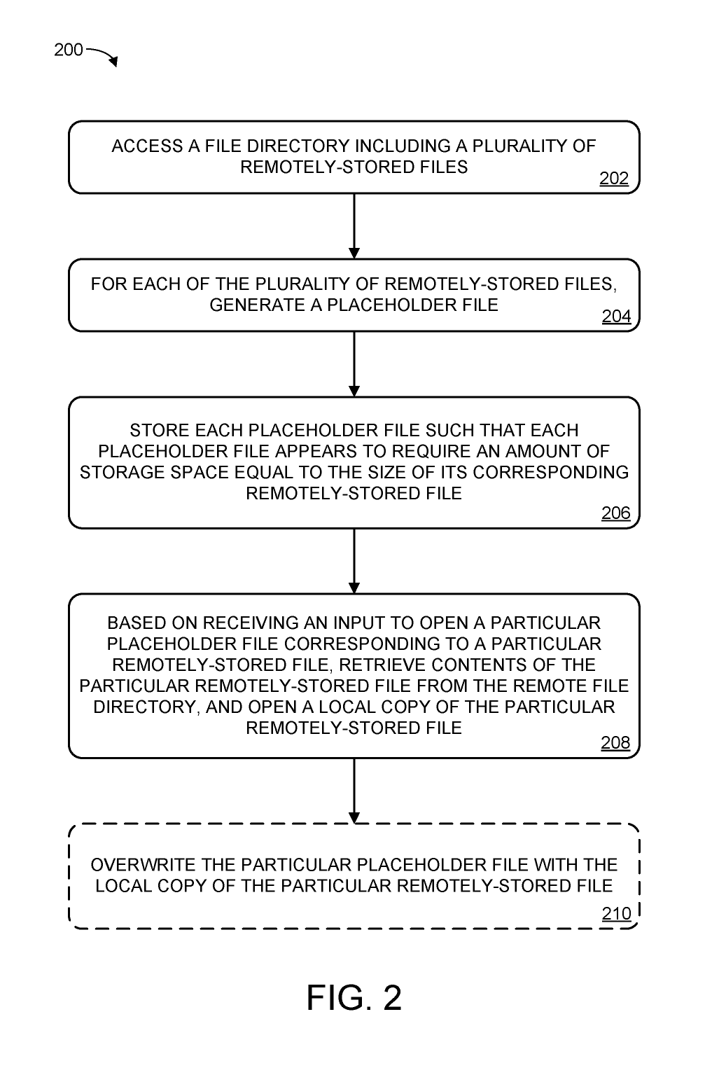

Accordingly, FIG. 2 illustrates an example method 200 for synchronizing local and remote file directories. At 202, method 200 includes accessing a file directory including a plurality of remotely-stored files. The file directory may be hosted by one or more remote computing devices, and may, for example, be associated with a remote file storage service, such as a remote source control service.

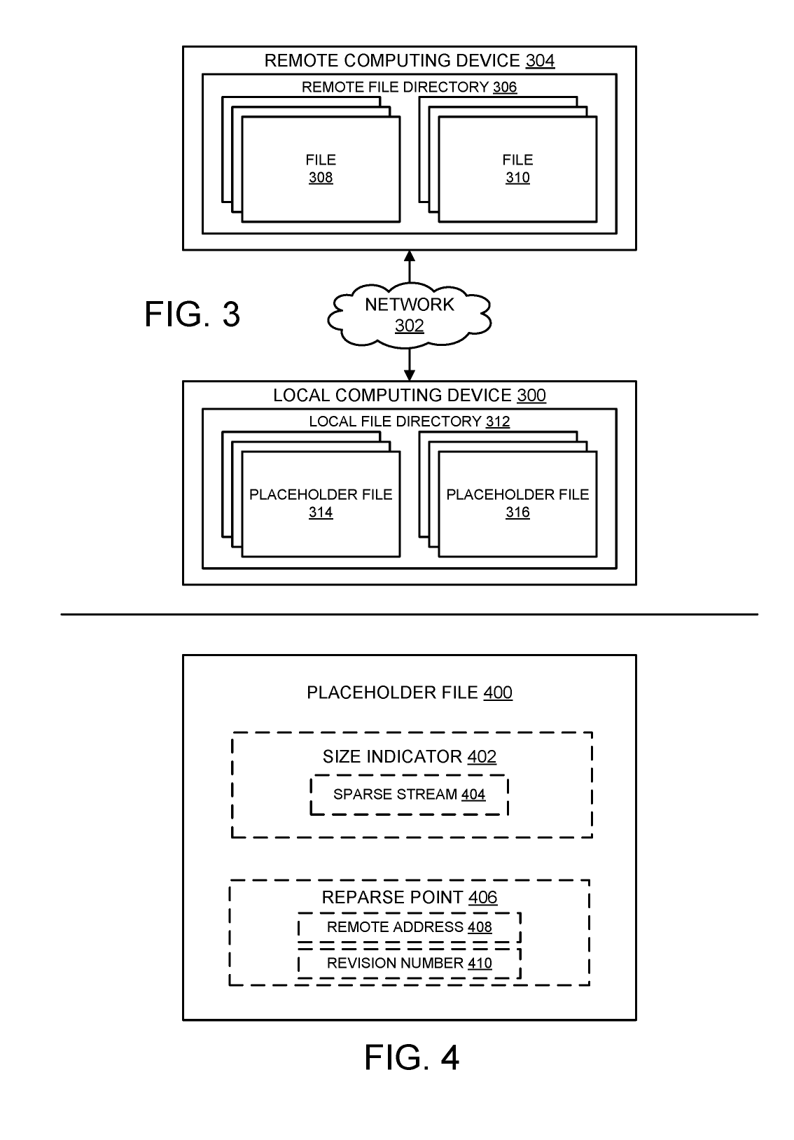

At 204, method 200 includes, for each of the plurality of remotely-stored files, generating a placeholder file on the local computing device. This is schematically illustrated in FIG. 3, which shows a local computing device 300. Via a network 302, local computing device 300 is communicatively coupled with a remote computing device 304. Remote computing device 304 includes a remote file directory 306, which in turn includes a plurality of remotely-stored files, including files 308 and 310. Local computing device 300 includes a local file directory 312, which in turn includes a plurality of placeholder files corresponding to the plurality of remotely-stored files. Specifically, placeholder file 314 corresponds to remotely-stored file 308, while placeholder file 316 corresponds to remotely-stored file 310.

As will be described in more detail below, a “placeholder file” is a computer file held on a local computing device that corresponds to a particular remotely-stored file held on a remote computing device. If the local file directory in which placeholder files are held utilizes the NTFS file system, then the placeholder files may take the form of virtual stub files. Placeholder files may be generated in any suitable way. As will be described in more detail below, a placeholder file, such as a virtual stub file, may be generated by source control management software installed on the local computing device, and/or other suitable software. In some cases, each placeholder file may be smaller in size than its corresponding remotely-stored file. For example, a placeholder file may include a variety of information describing properties of the remotely-stored file corresponding to the placeholder file, while including less than all of the data comprising the remotely-stored file.

Further, each placeholder file may be stored in the local file directory such that the local file directory mimics an organization of the remote file directory. In other words, if the remote file directory includes a particular file located in a particular folder, then the local file directory will include a placeholder file having the same name as the particular file, and held in a local version of the particular folder. Notably, however, the placeholder file will require less storage space to store on the local computing device than its corresponding remotely-stored file occupies on the remote computing device.

Based on detecting a change in the organization of the remote file directory, in some cases an organization of the local file directory may be automatically changed to mimic the new, changed organization of the remote file directory. For example, if the particular folder in which the particular remotely-stored file is moved or renamed, then software running on the local computing device may detect this change, and automatically apply it to the local file directory. In some cases, such an automatic change may only be made after the software explicitly requests that synchronization between the local and remote file directories be performed.

Returning briefly to FIG. 2, at 206, method 200 includes storing each placeholder file such that each placeholder file appears, from a perspective of an operating system of the local computing device, to require an amount of storage space equal to the size of its corresponding remotely-stored file. When this is done, then the local file directory in which each placeholder file is stored on the local computing device may appear, from the perspective of the operating system of the local computing device, to occupy an amount of storage space equal to a total size of each of the plurality of remotely-stored files.

In order to accomplish this, each placeholder file may include a size indicator indicating a size of the remotely-stored file corresponding to the placeholder file. FIG. 4 schematically shows an example placeholder file 400 including a variety of information describing attributes of the remotely-stored file to which the placeholder file corresponds. As shown, placeholder file 400 includes a size indicator 402. This size indicator may take a variety of suitable forms, depending on the specific implementation. For example, as indicated above, when the local computing device utilizes the NTFS file system, then each placeholder file may take the form of a virtual stub file. Accordingly, the size indicator of each virtual stub file may include a sparse stream, such as sparse stream 404.

A sparse stream may define a single range of storage addresses on storage media of the local computing device that is assumed to be essentially blank, or contain “zero.” As an example, a sparse stream may include a first value specifying a start position on a storage medium, and a second value specifying a number in bytes. Based on interpreting such values, the local computing device may be configured to report that the placeholder file occupies an amount of storage space on the storage medium equal to the number of bytes specified by the sparse stream.

A placeholder file may additionally, or alternatively, include other information describing attributes of its corresponding remotely-stored file. For example, in situations where the placeholder files are implemented as virtual stub files, then each virtual stub file may include a reparse point indicating a remote address of a remotely-stored file corresponding to the virtual stub file. This is shown in FIG. 4, as placeholder file 400 includes a reparse point 406 and a remote address 408. In the NTFS file system, a reparse point can include a variety of data that, when accessed by a file system, is automatically passed along to another software application or driver associated with the reparse point. In this case, a reparse point of a virtual stub file can include a remote network address, such as remote address 408, that points to the remotely-stored file corresponding to the virtual stub file. When the operating system of the local computing device is directed to access the virtual stub file, data from the reparse point is passed off to software associated with the remote file storage service, which then retrieves contents of the remotely-stored file from the one or more remote computing devices, as will be described in more detail below.

Reparse points can additionally, or alternatively, include other data beyond remote addresses. For example, each reparse point may further indicate a revision number of a remotely-stored file corresponding to the virtual stub file. This is shown in FIG. 4, as reparse point 406 includes a revision number 410. A revision number may take any suitable form, and may be updated each time the remotely-stored file corresponding to the virtual stub file is modified, for example. Other information included in a reparse point may include, for example, an identifier of the local computing device, a database identifier, a user or workspace identifier, a file size, etc. It will be understood that a placeholder file may include such information regardless of whether the placeholder file is a virtual stub file or includes a reparse point.

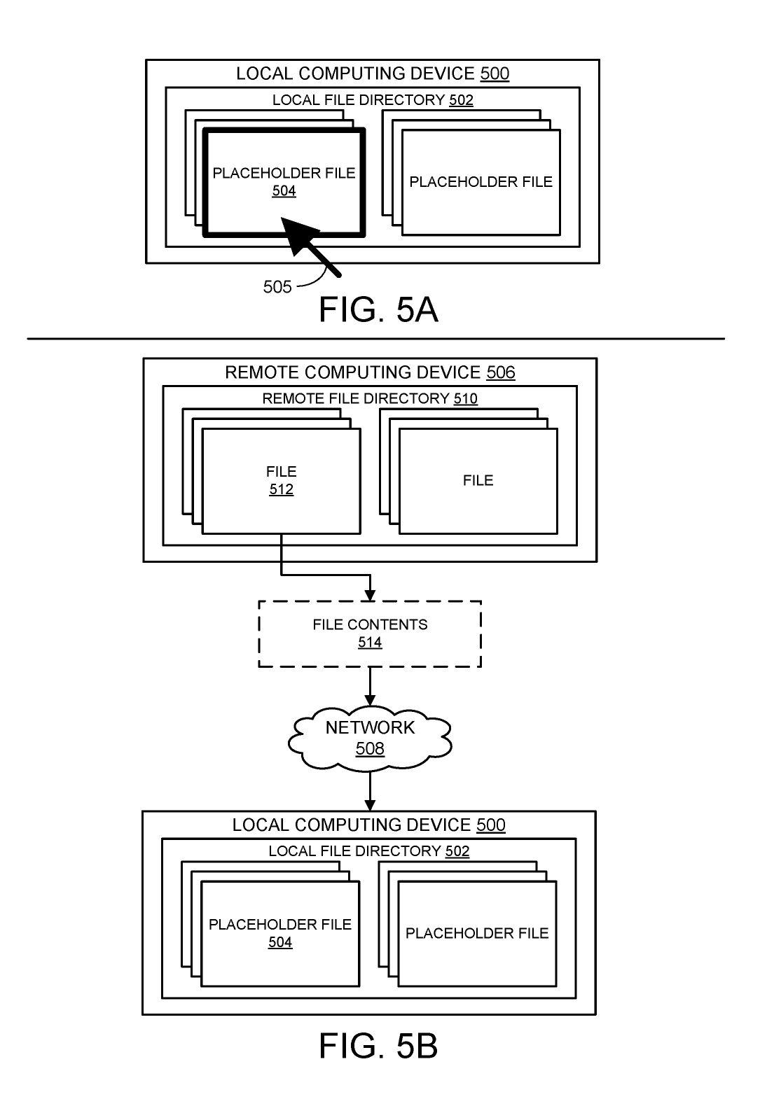

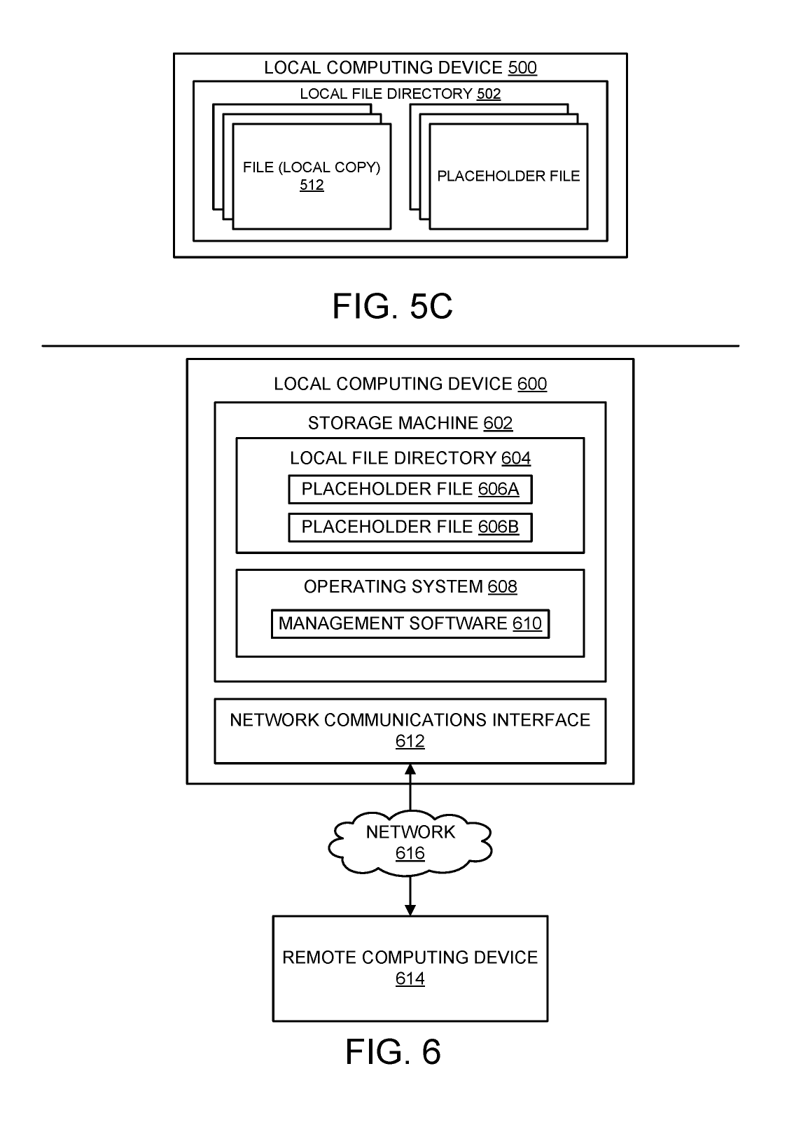

Returning briefly to FIG. 2, at 208, method 200 includes, based on receiving an input to open a particular placeholder file corresponding to a particular remotely-stored file, retrieving contents of the particular remotely-stored file from the remote file directory, and opening a local copy of the particular remotely-stored file. This process is schematically illustrated in FIGS. 5A-5C.

FIG. 5A schematically shows an example computing device 500 including a local file directory 502. Local file directory 502 includes a plurality of placeholder files corresponding to a plurality of remotely-stored files, including a placeholder file 504. As shown, local computing device 500 is receiving an input 505 to open placeholder 504. An input to open a particular placeholder file may be provided to a local computing device in any suitable way, via any suitable input interface. As examples, an input may be provided via a mouse click, button/keypress, touch input, spoken command, etc.

Upon receiving the input to open the particular placeholder file, the local computing device may retrieve contents of the remotely-stored file corresponding to the placeholder file. This is schematically illustrated in FIG. 5B, which shows local computing device 500 communicatively coupled with a remote computing device 506 via a network 508. Remote computing device 506 includes a remote file directory 510, including a file 512 that corresponds to placeholder file 504 of the local computing device. Local computing device 500 is retrieving file contents 514 of file 512 from the remote computing device. “File contents” as used herein may take any suitable form depending on the nature of the remotely-stored file, though in general will refer to any or all data contained within a remotely-stored file that is necessary for the creation of a local copy of the remotely-stored file.

Once the local computing device has retrieved the contents of the remotely-stored file, the local computing device will transfer the file contents into a local copy of the remotely-stored file, and open the local copy. This is shown in FIG. 5C, which shows a local copy of remotely-stored file 512 located in the local file directory 502 of local computing device 500. Notably, this process may take place “in the background,” such that it is not obvious to a user of the local computing device that the file contents were retrieved from a remote source. In this manner, the user may select what appears to be, for example, a digital video file from the local file directory, without being aware that the selected file is merely a placeholder file corresponding to the digital video file. The local computing device will report that the selected file has a size equal to the size of the digital video file, despite the placeholder file likely having a significantly smaller size than the digital video file. Should the user attempt to open the selected file, the local computing device will retrieve contents of the digital video file from the remote computing device, thereby creating a local copy of the digital video file, and open the local copy as the user expects.

Returning briefly to FIG. 2, at 210, method 200 optionally includes overwriting the particular placeholder file with the local copy of the particular remotely stored file. This is also shown in FIG. 5C, in which the local copy of remotely-stored file 512 has overwritten the placeholder file 504 previously stored in the local file directory. However, in other implementations, the placeholder file need not be overwritten once the local copy of the remotely-stored file is generated.

As indicated above, a variety of different types of computing devices may be used to perform the file directory synchronization techniques described herein. Nevertheless, FIG. 6 schematically illustrates an example local computing device 600 that may perform the techniques described above. Local computing device 600 includes a storage machine 602. As will be described in more detail below with respect to FIG. 7, a storage machine may include one or more physical devices configured to store data and/or instructions executable by a logic machine, such as a processor.

Storage machine 602 of local computing device 600 includes a local file directory 604, which in turn includes at least two placeholder files 606A and 606B. As described above, a local file directory may take any suitable form and be organized in any suitable way. In some cases, a local file directory may utilize the NTFS file system. In such cases, placeholder files 606A and 606B may be implemented as virtual stub files.

Storage machine 602 also includes an operating system 608. In some cases, operating system 608 may be implemented as the Windows® operating system developed by Microsoft Corporation®. However, it will be understood that a local computing device may incorporate any suitable operating system, or any other software usable to manage interactions between hardware and software resources of a computing device. Operating system 608 may be configured to access and manipulate data stored on storage machine 602. Accordingly, files held within the local file directory may be organized by the operating system and visually represented as part of a user interface.

Operating system 608 may include one or more packages/instances of management software 610. Management software 610 may represent one or more unique programs or applications, such as user-level applications, kernel-level drivers, etc., which may in some instances be provided by multiple parties/organizations. Management software 610 may be associated with a remote file storage service and configured to perform one or more of the file directory synchronization steps described herein. Specifically, management software 610 may be configured to synchronize changes made to remotely-stored files with the local computing device. As an example, if a remotely-stored file is renamed, moved, deleted, etc., management software 610 may be configured to apply such changes to a placeholder file corresponding to that remotely-stored file. In some implementations, management software 610 may be configured to retrieve file contents from a remote computing device based on receiving an input to open a placeholder file. Management software 610 may additionally or alternatively be configured to generate placeholder files on a local computing device, and/or interpret contents of placeholder files in order to, for example, report that the placeholder files occupy a specified amount of storage space. Management software 610 may be provided by an organization that owns/controls the remote file storage service, provided by a 3^{rd} party developer, provided as part of operating system 608, etc.

Local computing device 600 also includes a network communications interface 612. As will be described in more detail below with respect to FIG. 7, a network communications interface may generally be any suitable computer component that facilitates communication between the local computing device and one or more other computing devices. Specifically, as shown, network communications interface 612 enables communication between local computing device 600 and a remote computing device 614, via a network 616. As described above, remote computing device 614 may include a remote file directory including a plurality of remotely-stored files corresponding to the placeholder files stored on local computing device 600.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. In particular, computing system 700 may take the form of a local computing device configured to interact with one or more remote computing devices for the purpose of synchronizing a file system. Similarly, computing system 700 may take the form of a remote computing device, as described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, communications interface 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally, or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic machine 702 executing instructions held by storage machine 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communications interface 710 may be configured to communicatively couple computing system 700 with one or more other computing devices. Communications interface 710 may include wired and/or wireless communication devices compatible with one or more different communication protocols. As non-limiting examples, the communications interface may be configured for communication via a wireless telephone network, or a wired or wireless local- or wide-area network. In some embodiments, the communications interface may allow computing system 700 to send and/or receive messages to and/or from other devices via a network such as the Internet.

In an example, a method for synchronizing a file directory comprises: on a local computing device, accessing a remote file directory hosted by one or more remote computing devices and including a plurality of remotely-stored files; for each of the plurality of remotely-stored files, generating a placeholder file on the local computing device, each placeholder file being smaller in size than a remotely-stored file corresponding to the placeholder file, and each placeholder file including a size indicator indicating a size of the remotely-stored file corresponding to the placeholder file; on the local computing device, storing each placeholder file such that each placeholder file appears, from a perspective of an operating system of the local computing device, to require an amount of storage space equal to the size of its corresponding remotely-stored file; and on the local computing device, based on receiving an input to open a particular placeholder file corresponding to a particular remotely-stored file, retrieving contents of the particular remotely-stored file from the remote file directory, and opening a local copy of the particular remotely-stored file. In this example or any other example, the method further comprises overwriting the particular placeholder file with the local copy of the particular remotely-stored file. In this example or any other example, each placeholder file is stored on the local computing device in a local file directory organized such that it mimics an organization of the remote file directory. In this example or any other example, the local file directory in which each placeholder file is stored on the local computing device appears, from the perspective of the operating system of the local computing device, to occupy an amount of storage space equal to a total size of each of the plurality of remotely-stored files. In this example or any other example, the method further comprises, based on detecting a change in the organization of the remote file directory, automatically changing an organization of the local file directory to mimic the organization of the remote file directory. In this example or any other example, the remote file directory is associated with a remote source control service. In this example or any other example, each placeholder file is a virtual stub file. In this example or any other example, each virtual stub file includes a reparse point indicating a remote address of a remotely-stored file corresponding to the virtual stub file. In this example or any other example, each reparse point further indicates a revision number of a remotely-stored file corresponding to the virtual stub file. In this example or any other example, the size indicator of each placeholder file includes a sparse stream. In this example or any other example, each virtual stub file is generated by source control management software installed on the local computing device.

In an example, a local computing device comprises: a logic machine; and a storage machine holding instructions executable by the logic machine to: via a network communications interface, access a remote file directory hosted by one or more remote computing devices and including a plurality of remotely-stored files; for each of the plurality of remotely-stored files, generate a placeholder file on the local computing device, each placeholder file being smaller in size than a remotely-stored file corresponding to the placeholder file, and each placeholder file including a size indicator indicating a size of the remotely-stored file corresponding to the placeholder file; store each placeholder file on the local computing device such that each placeholder file appears, from a perspective of an operating system of the local computing device, to require an amount of storage space equal to the size of its corresponding remotely-stored file; and based on receiving an input to open a particular placeholder file corresponding to a particular remotely-stored file, retrieve, via the network communications interface, contents of the particular remotely-stored file from the remote file directory, and open a local copy of the particular remotely-stored file. In this example or any other example, the instructions are further executable to overwrite the particular placeholder file with the local copy of the particular remotely-stored file. In this example or any other example, each placeholder file is stored on the local computing device in a local file directory organized such that it mimics an organization of the remote file directory. In this example or any other example, the local file directory in which each placeholder file is stored on the local computing device appears, from the perspective of the operating system of the local computing device, to occupy an amount of storage space equal to a total size of each of the plurality of remotely-stored files. In this example or any other example, the placeholder file is a virtual stub file. In this example or any other example, each virtual stub file includes a reparse point indicating a remote address of a remotely-stored file corresponding to the virtual stub file. In this example or any other example, each reparse point further indicates a revision number of a remotely-stored file corresponding to the virtual stub file. In this example or any other example, the size indicator of each placeholder file includes a sparse stream.

In an example, a method for synchronizing a file directory comprises: on a local computing device, accessing a remote source control service hosted by one or more remote computing devices and including a plurality of remotely-stored files; for each of the plurality of remotely-stored files, generating a virtual stub file on the local computing device, each virtual stub file being smaller in size than a remotely-stored file corresponding to the virtual stub file, and each virtual stub file including a sparse stream indicating a size of the remotely-stored file corresponding to the virtual stub file; on the local computing device, storing each virtual stub file such that each virtual stub file appears, from a perspective of an operating system of the local computing device, to require an amount of storage space equal to the size of its corresponding remotely-stored file; and on the local computing device, based on receiving an input to open a particular virtual stub file corresponding to a particular remotely-stored file, retrieving contents of the particular remotely-stored file from the remote source control service, overwriting the virtual stub file with a local copy of the particular remotely-stored file, and opening the local copy of the particular remotely-stored file.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for synchronizing a file directory, comprising:
on a local computing device, accessing a remote file directory hosted by one or more remote computing devices and including a plurality of remotely-stored files;
for each of the plurality of remotely-stored files, generating a placeholder file on the local computing device, each placeholder file being smaller in size than a remotely-stored file corresponding to the placeholder file, and each placeholder file including a size indicator indicating a size of the remotely-stored file corresponding to the placeholder file;
on the local computing device, storing each placeholder file such that each placeholder file appears, from a perspective of an operating system of the local computing device, to require an amount of storage space equal to the size of its corresponding remotely-stored file; and
on the local computing device, based on receiving an input to open a particular placeholder file corresponding to a particular remotely-stored file, retrieving contents of the particular remotely-stored file from the remote file directory, and opening a local copy of the particular remotely-stored file.

2. The method of claim 1, further comprising overwriting the particular placeholder file with the local copy of the particular remotely-stored file.

3. The method of claim 1, where each placeholder file is stored on the local computing device in a local file directory organized such that it mimics an organization of the remote file directory.

4. The method of claim 3, where the local file directory in which each placeholder file is stored on the local computing device appears, from the perspective of the operating system of the local computing device, to occupy an amount of storage space equal to a total size of each of the plurality of remotely-stored files.

5. The method of claim 3, further comprising, based on detecting a change in the organization of the remote file directory, automatically changing an organization of the local file directory to mimic the organization of the remote file directory.

6. The method of claim 1, where the remote file directory is associated with a remote source control service.

7. The method of claim 1, where each placeholder file is a virtual stub file.

8. The method of claim 7, where each virtual stub file includes a reparse point indicating a remote address of a remotely-stored file corresponding to the virtual stub file.

9. The method of claim 8, where each reparse point further indicates a revision number of a remotely-stored file corresponding to the virtual stub file.

10. The method of claim 7, where the size indicator of each placeholder file includes a sparse stream.

11. The method of claim 7, where each virtual stub file is generated by source control management software installed on the local computing device.

12. A local computing device, comprising:
a logic machine; and
a storage machine holding instructions executable by the logic machine to:
via a network communications interface, access a remote file directory hosted by one or more remote computing devices and including a plurality of remotely-stored files;
for each of the plurality of remotely-stored files, generate a placeholder file on the local computing device, each placeholder file being smaller in size than a remotely-stored file corresponding to the placeholder file, and each placeholder file including a size indicator indicating a size of the remotely-stored file corresponding to the placeholder file;
store each placeholder file on the local computing device such that each placeholder file appears, from a perspective of an operating system of the local computing device, to require an amount of storage space equal to the size of its corresponding remotely-stored file; and
based on receiving an input to open a particular placeholder file corresponding to a particular remotely-stored file, retrieve, via the network communications interface, contents of the particular remotely-stored file from the remote file directory, and open a local copy of the particular remotely-stored file.

13. The local computing device of claim 12, where the instructions are further executable to overwrite the particular placeholder file with the local copy of the particular remotely-stored file.

14. The local computing device of claim 12, where each placeholder file is stored on the local computing device in a local file directory organized such that it mimics an organization of the remote file directory.

15. The local computing device of claim 14, where the local file directory in which each placeholder file is stored on the local computing device appears, from the perspective of the operating system of the local computing device, to occupy an amount of storage space equal to a total size of each of the plurality of remotely-stored files.

16. The local computing device of claim 12, where the placeholder file is a virtual stub file.

17. The local computing device of claim 16, where each virtual stub file includes a reparse point indicating a remote address of a remotely-stored file corresponding to the virtual stub file.

18. The local computing device of claim 17, where each reparse point further indicates a revision number of a remotely-stored file corresponding to the virtual stub file.

19. The local computing device of claim 16, where the size indicator of each placeholder file includes a sparse stream.

20. A method for synchronizing a file directory, comprising:
on a local computing device, accessing a remote source control service hosted by one or more remote computing devices and including a plurality of remotely-stored files;
for each of the plurality of remotely-stored files, generating a virtual stub file on the local computing device, each virtual stub file being smaller in size than a remotely-stored file corresponding to the virtual stub file, and each virtual stub file including a sparse stream indicating a size of the remotely-stored file corresponding to the virtual stub file;
on the local computing device, storing each virtual stub file such that each virtual stub file appears, from a perspective of an operating system of the local computing device, to require an amount of storage space equal to the size of its corresponding remotely-stored file; and
on the local computing device, based on receiving an input to open a particular virtual stub file corresponding to a particular remotely-stored file, retrieving contents of the particular remotely-stored file from the remote source control service, overwriting the virtual stub file with a local copy of the particular remotely-stored file, and opening the local copy of the particular remotely-stored file.
